(19) United States
(12) Patent Application Publication
(10) Pub. No.: US 2018/0223789 A1
(43) Pub. Date: Aug. 9, 2018

(54) COIL SECURE BRACKET SYSTEM AND METHOD

(71) Applicant: Dennis Koomans, Chatham (CA)

(72) Inventor: Dennis Koomans, Chatham (CA)

(21) Appl. No.: 15/428,649

(22) Filed: Feb. 9, 2017

(51) Int. Cl. F02P 3/02

(52) U.S. Cl. CPC F02P 3/02

(57) ABSTRACT

A coil secure bracket system including a bracket assembly, a plurality of threaded-studs to removably couple to the bracket assembly via a plurality of first-machined-holes in the bracket assembly, and to an engine valve cover. Also included is a plurality of nuts configured to coupled to the bracket assembly by the plurality of threaded-studs, a plurality of set-screws to removably couple to the bracket assembly via the plurality of second-threaded-holes to hold the engine ignition coils to the engine, a plurality of jam-nuts removably coupled to the set-screws to maintain the set-screws in the bracket assembly. The coil secure bracket system is useful for securing engine ignition coils to the engine when the exiting fastening means has become damaged such that a replacement of engine valve covers may be required.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of internal combustion engines of existing art and more specifically relates to brackets for inductor devices.

### 2. Description of Related Art

In the automotive industry, the coil on plug ignition system has become a widely used ignition system for gasoline engines; however some problems with such systems exist. For example, Ford 5.0 Liter engines, as installed on 2011 and newer models have seen problems with the coil on plug ignition system. Generally, the coil retaining bolts that thread into molded inserts in the valve cover(s) are prone be to be broken off, or the inserts spinning in the composite plastic cover(s) due to corrosion and/or decay.

In most cases, such damage repairs require the replacement of valve covers which can be costly. Additionally, much time is often required to replace valve covers as many engine components must be removed, as well as the chance of getting dirt, debris, and/or water into the engine during valve cover replacement. As with the coil retaining bolts, valve cover bolts can also be prone to corrosion, which makes replacement time consuming and difficult. A suitable solution is desired.

U.S. Pat. No. 7,997,256 to David Iwanicki relates to a hinged removable coil mount. The described hinged removable coil mount includes an ignition coil assembly mounted on a valve cover where the coils connected to the ignition coil assembly are individually removable. The ignition coil assembly includes a base plate and coil bracket that are rotateably coupled, allowing for access and removal of individual coils as from the engine or valve cover. The coil bracket is also able to be removed from the base member. Also included are a method for manufacture of the ignition coil assembly and a method for replacing ignition coils from an engine.

### BRIEF SUMMARY OF THE INVENTION

In view of the foregoing disadvantages inherent in the known internal combustion engine art, the present disclosure provides a novel coil secure bracket system and method. The general purpose of the present disclosure, which will be described subsequently in greater detail, is to provide a device which will retain engine ignition coils to the valve covers of an engine where the valve covers may be damaged in lieu of replacing the valve covers when the factory ignition coil fasteners become damaged.

A coil secure bracket system is disclosed herein. The coil secure bracket system includes a bracket assembly, a plurality of threaded-studs, a plurality of nuts, a plurality of set-screws, a plurality of jam-nuts, a plurality of washers, and a plurality of spacers.

In an embodiment, the bracket assembly includes at least a top-face, a bottom-face, an exterior-edge, a plurality of first-machined-holes, and a plurality of second-threaded-holes. The bracket assembly additionally includes openings to allow access to the engine valve cover and to promote cooling of the engine and reduce overall weight of the bracket assembly. The plurality of threaded-studs are configured to be removably coupleable to the bracket assembly by passing through the plurality of first-machined-holes, and also to an engine valve cover by threading the plurality of threaded-studs into the composite bosses that are already existing in the engine valve cover. Each threaded-stud preferably includes a top thread and a bottom thread, and a plurality of selective spacers to adjust the height of the bracket.

The plurality of nuts are configured to be removably coupleable to the bracket assembly by threading onto the plurality of threaded-studs, in preferred embodiments. Similarly, the plurality of set-screws is removably coupleable to the bracket assembly by threading into the plurality of second-threaded-holes. Such an arrangement is configured to maintain the plurality of engine ignition coils upon the engine in a secure fashion.

Preferably, the plurality of jam-nuts are removably coupleable to the plurality of set-screws and are configured to maintain the set-screws in a desired position within the bracket assembly when the set-screws are maintaining the engine ignition coils to the engine. The bracket assembly is intended to be interchangeable such that it may be used on either side of an engine (which includes two of engine valve covers, both a right and a left). The bracket assembly is also configurable to accommodate an in-line engine which includes a single valve cover.

According to another embodiment, a method of using a coil secure bracket system is also disclosed herein. The method of using a coil secure bracket system includes a first step, providing a vehicle, the vehicle including (a) valve cover(s), spark-plugs, and a plurality of ignition coils; a second step, providing a coil secure bracket system; a third step, removing the plurality of ignition-coils; a fourth step, removing the spark-plugs from the vehicle; a fifth step, installing new spark-plugs; a sixth step, installing studs into the valve cover(s); a seventh step, placing the coil secure bracket system onto the studs; an eight step, threading nuts onto the studs to secure the coil secure bracket system; a ninth step; installing a plurality of set-screws into the coil secure bracket systems to secure the plurality of ignition-coils to the valve cover(s), and a tenth step, installing jam-lock-nuts to secure the set-screws. It must be noted that not all steps in the method of use are required in all instances.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a coil secure bracket system and method, constructed and operative according to the teachings of the present disclosure.

FIG. 1 is a perspective view of the coil secure bracket system during an ‘in-use’ condition, according to an embodiment of the disclosure.

FIG. 2 is a front view of the coil secure bracket system of FIG. 1, according to an embodiment of the present disclosure.

FIG. 3 is a perspective view of the coil secure bracket system of FIG. 1, according to an embodiment of the present disclosure.

FIG. 4 is an assembly view of the coil secure bracket system of FIG. 1, according to an embodiment of the present disclosure.

FIG. 5 is a flow diagram illustrating a method of use for securing engine ignition coils to an engine via a coil secure bracket system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to brackets for induction devices of internal combustion engines and more particularly to a coil secure bracket system and method as used to improve the securing of engine ignition coils to a valve cover of an engine when the original/factory fastening system of the engine ignition coils or valve cover(s) may become damaged and/or require replacement of the engine valve cover(s).

Generally, special threaded studs may be installed on the affected engine valve cover(s) on composite bosses that are already injection molded onto the existing engine valve cover(s). The bracket assembly may slide onto the threaded studs and fastened with nuts. Four set-screws may be turned into a plurality of second-threaded-holes in the bracket assembly, centering in the coil bolt hole sleeves (and therefore the engine ignition coils). Then, a jam-nut locks each set screw into place, securing the engine ignition coils.

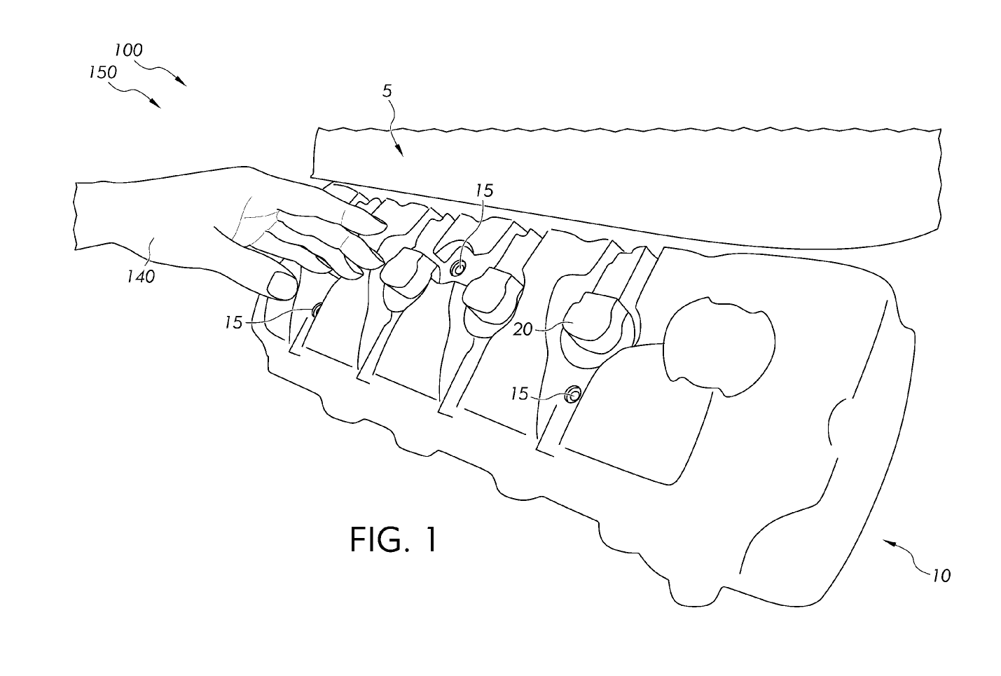

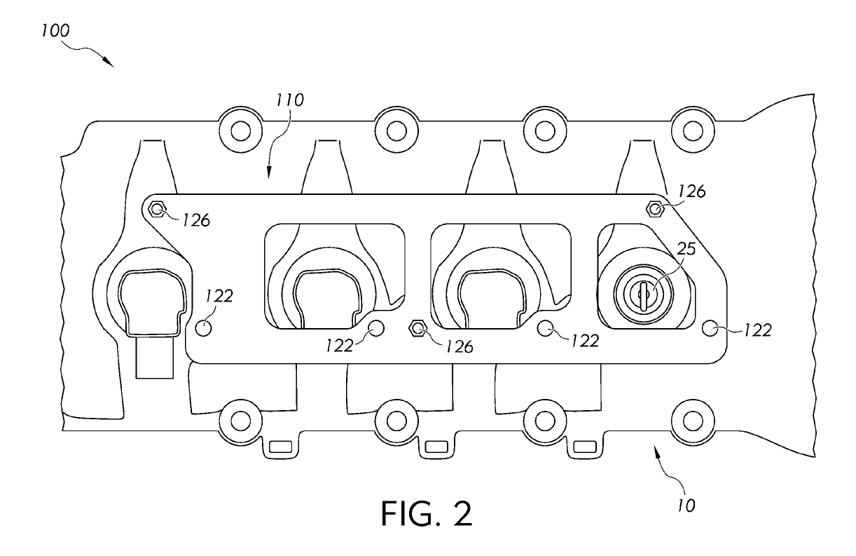

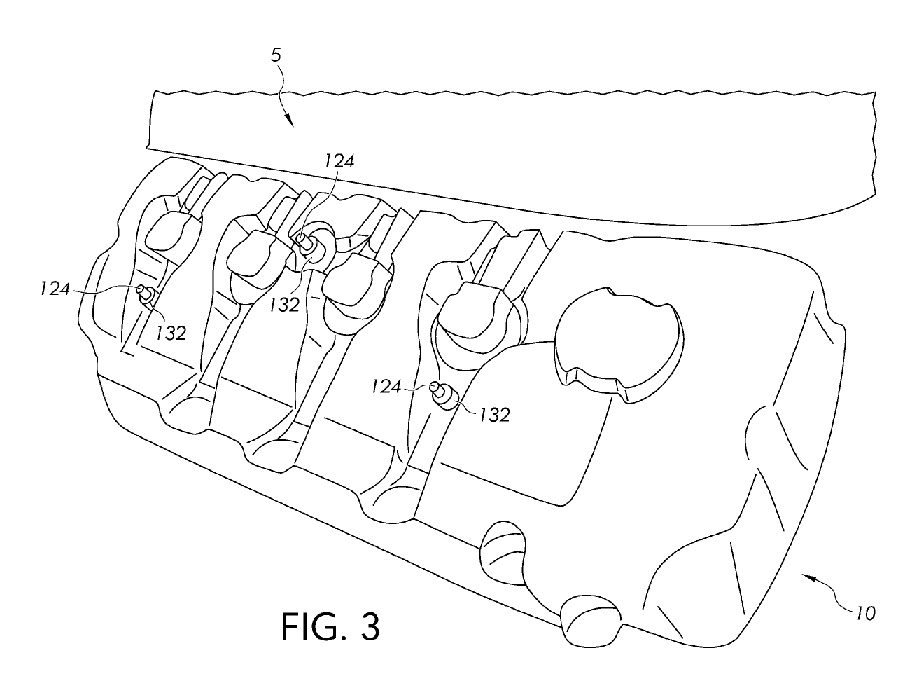

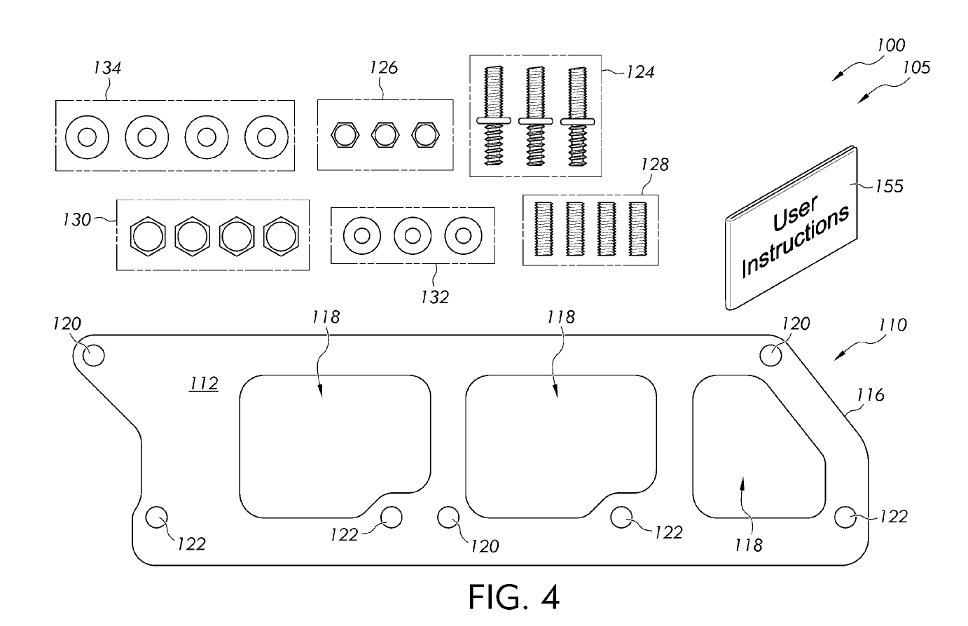

Referring now more specifically to the drawings by numerals of reference, there is shown in FIGS. 1-4, various views of a coil secure bracket system 100. FIG. 1 shows a coil secure bracket system during an ‘in-use’ condition 150, according to an embodiment of the present disclosure. Here, the coil secure bracket system 100 may be beneficial for use by a user 140 to affix engine ignition coils 20 to an engine 5 when the fasteners or engine valve cover(s) 10 becomes damaged such that replacement of the engine valve cover(s) 10 may be required. Such damage may be commonly found when user 140 is in the process of changing/replacing spark-plugs 25 on engine 5.

As illustrated in FIGS. 1-4, the coil secure bracket system 100 may include bracket assembly 110, plurality of threaded-studs 124, plurality of nuts 130, plurality of set-screws 128, and plurality of nuts 126. Bracket assembly 110 may be interchangeable such that bracket assembly 110 can used on either side of engine 5, where engine 5 may include two engine valve covers 10, a right and a left. Some embodiment may include engine 5 that includes only one engine valve cover 10.

Bracket assembly may include top-face 112, a bottom-face (not shown), exterior-edge 116, plurality of first-machined-holes 120, and plurality of second-threaded-holes 122. Bracket assembly 110 may also include openings 118 to allow access to engine valve cover 10 and to promote cooling of engine 5 and reduce overall weight of bracket assembly 110. Plurality of threaded-studs 124 may be configured to be removably coupleable to bracket assembly 110 via plurality of first-machined-holes 120 and plurality of nuts 126, and additionally to engine valve cover 10 by threading into composite bosses 15 existing in engine valve cover 10, where each of threaded-studs 124 includes a top thread and a bottom thread.

Each of plurality of threaded-studs 124 may be constructed from a material that is designed to be threaded into plastic (e.g., plastic, composite, etc.) to thread into composite bosses 15 of engine valve cover 10. Each of plurality of threaded-studs 124 may include a bottom thread which comprises a 9/32-inch self-tapping thread, and a top thread that comprises a ¼-inch standard coarse thread. Coil secure bracket system 100 may further include plurality of spacers 132 configured to fit between the bottom thread of each of plurality threaded-stud(s) 124 and composite bosses 15 to provide adequate clearance between bracket assembly 110 and engine valve cover 10 (and therefore engine ignition coils 20).

Plurality of nuts 126 may be configured to removably and securely couple bracket assembly 110 to plurality of threaded-studs 124. Similarly, plurality of set-screws 128 may removably couple to bracket assembly 110 via plurality of second-threaded-holes 122 to maintain the engine ignition coils 20 upon engine 5. Plurality of jam-nuts 130 may removably couple to plurality of set-screws 128 and are configured to maintain plurality set-screws 128 in a desired position within bracket assembly 110 (and therefore upon engine ignition coils 20).

Each of the plurality of set-screws 128 may contact ignition coils 20 at a substantially perpendicular angle, in some embodiments. Accordingly, each of the second-threaded-holes 122 may be configured at substantially a 7½ degree angle in relation each to the top-face 112 and the bottom-face 114 of bracket assembly 110. Other embodiments may include other angles as needed for specific applications. Some embodiments may include plurality of tapered washers 134, each installed beneath one of plurality of jam-nuts 130 to account for angles which are not perpendicular. Each of plurality of set-screws 128, plurality of nuts 126, and plurality of jam-nuts 130 may be constructed from a corrosion resistant material.

In embodiments, bracket assembly 110 may be constructed from a ferrous-metallic material configured to increase durability and longevity during use. Bracket system 100 may further include an anti-corrosion coating, with the anti-corrosion coating applied by a powder-coating process, in some embodiments. Bracket assembly 110 may be constructed by cutting via a waterjet. Other embodiments may include other materials, coatings, and manufacturing processes, dependent upon user preferences, manufacturing cost, and specification applications.

Coil secure bracket system 100 may be configured to affix to a 5.0 liter Ford engine, where the 5.0 liter Ford engine is installed within a model year 2011 or newer F-150 pickup truck. Other embodiments may include other vehicle makes, models, and engine configurations.

According to one embodiment, the coil secure bracket system 100 may be arranged as a kit 105. In particular, the coil secure bracket system 100 may further include a set of instructions 155. The instructions 155 may detail functional relationships in relation to the structure of the coil secure bracket system 100 (such that the coil secure bracket system 100 can be used, maintained, or the like, in a preferred manner).

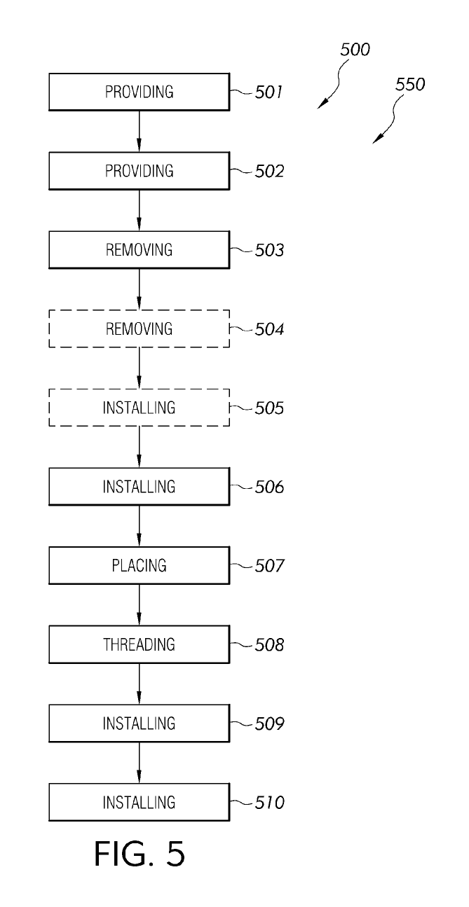

FIG. 5 is a flow diagram illustrating a method of using a coil secure bracket system, according to an embodiment of the present disclosure. In particular, method of using 500 a coil secure bracket system 100 may include one or more components or features of the coil secure bracket system 100 as described above. As illustrated, method of using 500 a coil secure bracket system 100 may include the steps of: step one 501, providing a vehicle; the vehicle including valve covers, spark-plugs, and a plurality of ignition coils; step two 502, providing a coil secure bracket system; step three 503, removing the plurality of ignition-coils; step four 504, removing the spark-plugs from the vehicle; step five 505, installing new-spark-plugs into the vehicle; step six 506, installing studs into the valve cover; step seven 507, placing the coil secure bracket system onto the studs; step eight 508, threading nuts onto the studs to secure the coil secure bracket system; step nine 509; installing a plurality of set-screws into the coil secure bracket systems to secure the plurality of ignition-coils to the valve covers, and step ten 510, installing jam-lock-nuts to secure the set-screws.

It should be noted that step four 504 and step five 505 optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods of using a coil secure bracket system (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A coil secure bracket system, the system comprising:
a bracket assembly including a top-face, a bottom-face, an exterior-edge, plurality of first-machined-holes, and a plurality of second-threaded-holes;
a plurality of threaded-studs configured to be removably coupleable to the bracket assembly via the plurality of first-machined-holes and a plurality of nuts, and to an engine valve cover via composite bosses existing in the engine valve cover, each threaded-stud including a top thread and a bottom thread;
said plurality of nuts configured to removably couple the bracket assembly to the plurality of threaded-studs;
a plurality of set-screws removably coupleable to the bracket assembly via the plurality of second-threaded-holes to maintain the plurality of engine ignition coils upon the engine; and
a plurality of jam-nuts removably coupleable to the plurality of set-screws configured to maintain the set-screws in a desired position within the bracket assembly.

2. The coil secure bracket system of claim 1, wherein the coil secure bracket system further includes a plurality of spacers configured to fit between the bottom thread of the threaded-stud and the composite bosses.

3. The coil secure bracket system of claim 1, wherein each of the plurality of threaded-studs are constructed from a material that is design to be threaded into plastic to thread into the composite bosses of the engine valve cover.

4. The coil secure bracket system of claim 1, wherein the bracket assembly includes openings to allow access to the engine valve cover and to promote cooling of the engine and reduce overall weight of the bracket assembly.

5. The coil secure bracket system of claim 1, wherein the bracket assembly is interchangeable such that the system may be used on either side of the engine which includes two of said engine valve covers, a right and a left.

6. The coil secure bracket system of claim 1, wherein each of the plurality of set-screws contact the ignition coils at a substantially perpendicular angle.

7. The coil secure bracket system of claim 1, wherein each of the second-threaded-holes are configured at substantially a 7½ degree angle in relation each the top-face and the bottom-face of the bracket assembly.

8. The coil secure bracket system of claim 7, further comprising a plurality of tapered washers each installed beneath each one of one of plurality of jam-nuts.

9. The coil secure bracket system of claim 1, wherein the coil secure bracket system further includes an anti-corrosion coating.

10. The coil secure bracket system of claim 5, wherein the anti-corrosion coating is applied by a powder-coating process.

11. The coil secure bracket system of claim 1, wherein the bracket assembly is constructed by cutting via a waterjet.

12. The coil secure bracket system of claim 1, wherein each of the plurality of threaded-studs include a bottom thread which comprises a 9/32-inch self-tapping thread, and a top thread that comprises a ¼-inch standard coarse thread.

13. The coil secure bracket system of claim 1, wherein the bracket assembly is constructed from a ferrous-metallic material configured to increase durability and longevity during use.

14. The coil secure bracket system of claim 1, wherein each of the plurality of set-screws, plurality of nuts, and each of the plurality of jam-nuts are each constructed from a corrosion resistant material.

15. The coil secure bracket system of claim 1, wherein the system is configured to affix to a 5 liter Ford engine.

16. The coil secure bracket system of claim 15, wherein the 5 liter Ford engine is installed within a model year 2011 or newer F-150 pickup truck.

17. A coil secure bracket system, the system comprising:
a bracket assembly including a top-face, a bottom-face, an exterior-edge, plurality of first-machined-holes, a plurality of second-threaded-holes, and a plurality of openings to allow access to the engine valve cover and to promote cooling of the engine and reduce overall weight of the bracket assembly;
a plurality of threaded-studs configured to be removably coupleable to the bracket assembly via the plurality of first-machined-holes and a plurality of nuts, and to an engine valve cover via composite bosses existing in the engine valve cover, each threaded-stud including a top thread and a bottom thread;
said plurality of nuts configured to removably couple the bracket assembly to the plurality of threaded-studs;
a plurality of set-screws removably coupleable to the bracket assembly via the plurality of second-threaded-holes to maintain the plurality of engine ignition coils upon the engine, each of the plurality of threaded-studs constructed from a material that is designed to be threaded into plastic in order to thread into the composite bosses of the engine valve cover;
a plurality of jam-nuts removably coupleable to the plurality of set-screws configured to maintain the set-screws in a desired position within the bracket assembly;
a plurality of spacers configured to fit between the bottom thread of the threaded-stud and the composite bosses;
a plurality of tapered washers each installed beneath each one of one of plurality of jam-nuts;
wherein the bracket assembly is interchangeable such that it may be used on either side of the engine which includes two of said engine valve covers, a right and a left;
wherein each of the plurality of set-screws contact the ignition coils at a substantially perpendicular angle;
wherein each of the second-threaded-holes are configured at substantially a 7½ degree angle in relation each of the top-face and the bottom-face of the bracket assembly;
wherein the bracket assembly is constructed from a ferrous-metallic material configured to increase durability and longevity during use and includes an anti-corrosion coating and the anti-corrosion coating is applied by a powder-coating process;
wherein the bracket assembly is constructed by cutting via a waterjet;
wherein each of the plurality of threaded-studs include a bottom thread which is 9/32-inch self-tapping thread, and a ¼-inch standard coarse thread said bottom thread;
wherein each of the plurality of set-screws, plurality of nuts, and each of the plurality of jam-nuts are each constructed from a corrosion resistant material.
wherein the system is configured to affix to a 5 liter Ford engine; and
wherein the 5 liter Ford engine is installed within a model year 2011 or newer F-150 pickup truck.

18. The system of claim 17, further comprising set of instructions; and
wherein the system is arranged as a kit.

19. A method of using a coil secure bracket system, the method comprising the steps of:
providing a vehicle, the vehicle including valve covers, spark-plugs, and a plurality of ignition coils;
providing a coil secure bracket system;
removing the plurality of ignition-coils;
installing studs into the valve cover;
placing the coil secure bracket system onto the studs;
threading nuts onto the studs to secure the coil secure bracket system;
installing a plurality of set-screws into the coil secure bracket systems to secure the plurality of ignition-coils to the valve covers; and
installing jam-lock-nuts to secure the set-screws.

20. The method of claim 19, further comprising the steps of:
removing the spark-plugs from the vehicle; and
installing new-spark-plugs into the vehicle.
